(19) United States
(12) Patent Application Publication
(10) Pub. No.: US 2008/0306914 A1
(43) Pub. Date: Dec. 11, 2008

(54) Method and system for performing a search

(75) Inventor: Peter Jensen, Brussels (BE)

Correspondence Address: BIRCH STEWART KOLASCH & BIRCH, PO BOX 747, FALLS CHURCH, VA, 22040-0747, US

(73) Assignee: SEARCH CAPITAL LTD, Central (HK)

(21) Appl. No.: 11/806,999

(22) Filed: Jun. 5, 2007

(51) Int. Cl. G06F 17/30

(52) U.S. Cl. 707/3; 707/E17.108

(57) ABSTRACT

A method and computer system for searching for documents satisfying a search query. A client application in an electronic device displays a user interface with a text input field and a plurality of selectable categories, receives user input including a text string representing search terms and a selection of one or more categories, and transmits the text string and selected categories as first and second parts, respectively, of a query to a database. The database contains an index of documents categorized according to the selectable categories. After receiving from the database a listing of documents fulfilling both parts of the query, the client application presents the listing as part of the user interface along with the input field and selectable categories. Upon receiving new user input updating the first and/or second part of the query, the client application transmits the updated query to the database.

### TECHNICAL FIELD

The present invention relates generally to search engine front ends and back ends, and more particularly to a user interface and a search engine for performing categorized and classified searches.

### BACKGROUND

Web pages and other electronic sources of information accessible over the Internet represent a vast source of information on numerous subjects. However, the information available in this way is not organized, and it is a challenging task for users to find information that is relevant and trustworthy.

Popular search engine services, such as the one provided by Google Inc., provide users with a search through all documents that have been indexed by the search engine. This may be referred to as a horizontal search, since all documents are treated equally. There is no prior classification of documents before the search is performed. The documents that fulfill the search query are ranked, primarily based on link analysis methods.

Other services provide a certain degree of prior classification of information, addressing the needs of e.g. professionals. User's of such services perform searches within particular domains of information, and such searches may be referred to as vertical searches.

Even within a particular domain (such as a profession) user's may have different needs. Specialized subgroups of a user group may exist, and they may be too numerous for one vertical search domain to be set up for each group.

### SUMMARY OF THE INVENTION

The present invention relates to methods, computer systems and computer program products for searching for documents indexed and categorized in one or more databases. The documents may be categorized as belonging to one or more categories, and search requests may include a combination of a text string and an identification of which categories to search. In some embodiments a search request may also indicate a preferred ranking method for ranking the documents retrieved as a result of the search. A user interface on a client computer may present results along with an easy way to refine the search by changing the categories and/or ranking methods to use during the search and request an updated search using the original or an updated search string or search expression.

A computer system for receiving search requests and performing searches in the databases may be configured to transmit the original search query along with the results of the search such that the original search query can be entered into a user interface as default start values for an updated search, making it easy for a user to update the search query.

According to some embodiments, the categories of documents represent the origin of the documents and each document is defined to only have one unique origin. The database may then be a vertical database, i.e. a database containing documents relevant to a particular topic, and the origin may represent a set or category of entities that provide documents relating to the topic.

The invention is defined by the appended, independent claims. Further aspects and details are set forth in the appended, dependent claims.

Other features and aspects of the invention will be understood from the detailed description and the attached drawings below.

### BRIEF DESCRIPTION OF THE DRAWINGS

FIG. 1 shows a block diagram of a system configured to operate in accordance with an embodiment of the invention,

FIG. 2 shows a user interface displayed on an electronic client device and configured to receive search requests from a user and to display search results, and

FIG. 3 shows a flow chart illustrating a method according to the invention.

### DESCRIPTION OF EXEMPLARY EMBODIMENTS

The rapid growth of the world-wide web poses unprecedented scaling challenges for general-purpose search engines. Consistent with the principles of the present invention, a new vertical search system may be based on a combination of controlled crawling, classification and domain specific indexing. This may make it possible to selectively seek out and index pages that are relevant to a professional domain, or some other domain defined by how the pages relate to a predefined topic or set of topics. The topics may be specified by keywords, or alternatively by using exemplary documents. Rather than collecting and indexing all accessible web documents to be able to answer all possible ad-hoc queries, a vertical search system may index pages that are likely to be most relevant for a particular domain and avoids irrelevant regions of the web. (It should be understood that domain here refers to the topical domain defined by a profession, a hobby, or some other particular field of knowledge or information, not to Internet domains defined by domain names.)

The seeking out and indexing of pages relevant to a specific topic may be referred to as focused indexing. Focused indexing means that only a certain subset of available web pages will be indexed based on a certain rule. The content of a page that is indexed is analyzed and categorized. If it fits in a given list of interests, then the page is stored and the links that are stored in that page may be marked as candidates for further indexing in a web crawler like process. As an example the rule may be that if the content of the page can be defined as “medical”, including all the aspects of the medical area (doctors, patients, diseases, treatments, medications, hospitals, research, etc), the page should be included in a database where the topic is medical information.

According to certain principles of the invention, the topical domains may be categorized not only according to general topical information, but according to information about the source from which each document came. Continuing with the medical example, categories could then be government, schools, journals, pharmaceutical companies, hospitals, organizations and commercial sources. This categorization may serve several purposes. First, if the user is searching for a particular document he or she knows came from a particular source (e.g. a journal), it will be easier to find the document. Second, some users may prefer particular sources because they consider them more trustworthy. Also, users may simply look for different types of information at different times, finding different sources to be more likely to provide them with the best hits for different searches.

According to some embodiments of the invention, alternative schemes may be used to rank the documents that are provided as the result of a search. This provides yet another way for users to refine their searches. An example of this principle would be where documents are ranked according to their relevance to general, disease, medication and technology. The invention is not limited to any particular one method for ranking documents. One alternative consistent with the invention would simply be to rank all documents manually by experts. Another alternative is to collect feedback from user's as they find the various documents during searches. Yet another alternative is to score the documents based on the occurrence of the user's search terms, possibly in combination with the additional terms representing the ranking scheme (e.g. disease, medication and technology, with general as the default ranking that is not influenced by the presence of additional terms). Another alternative that is consistent with the principles of the invention is to use some form of link analysis for ranking, and let the presence of the additional terms (e.g. disease, medication and technology) influence the graph or add weight to links or nodes in the graph prior to performing the link analysis. It is also consistent with embodiments of the invention to use combinations of several methods for ranking.

It should be understood that the expression “search terms” is intended to include a string of one or more words that are must be included in and/or excluded from a document for that document to fulfill the search query, as well as phrases and regular expressions including such words.

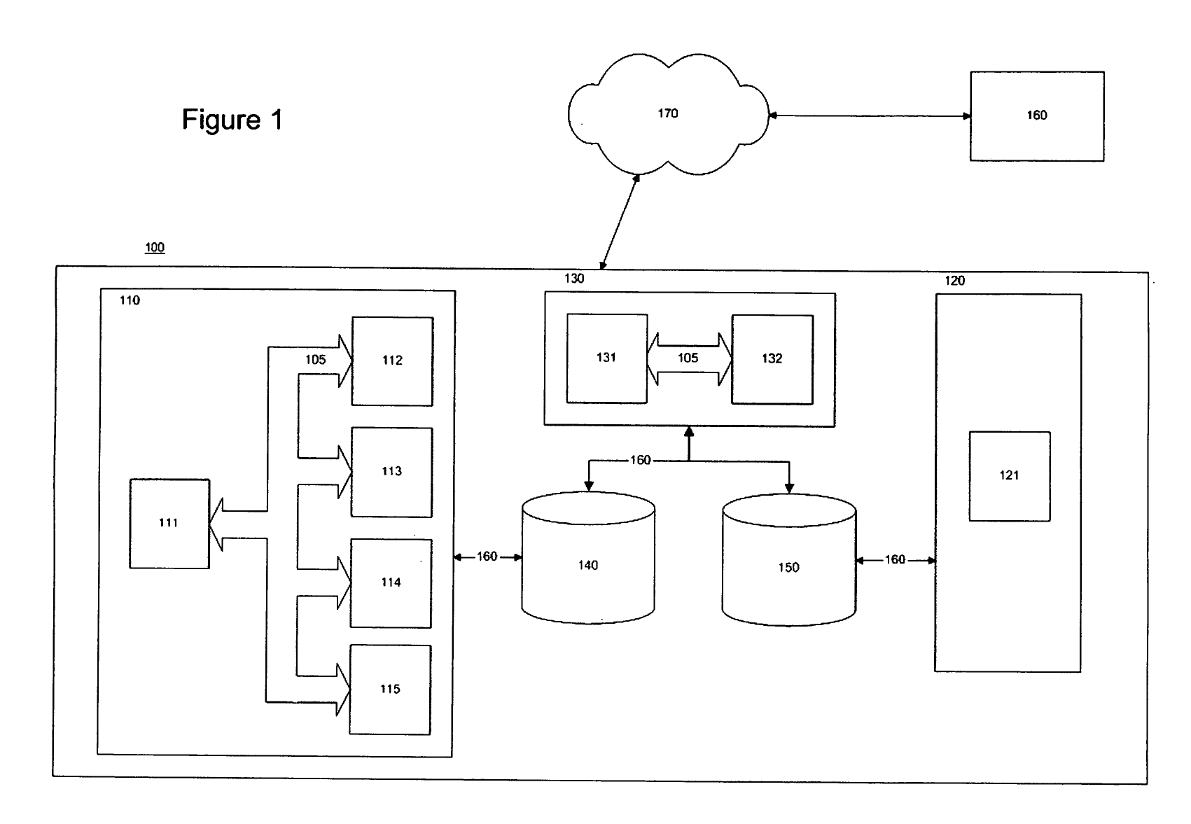

Reference is first made to FIG. 1, which is a block diagram of a system 100 configured to operate at the server back end side in accordance with an embodiment of the invention.

The exemplary system 100 as illustrated in FIG. 1 includes two subsystems, a vertical database generation subsystem 110, and a searching subsystem 130. The system 100 may also include a vertical information database 140.

The first subsystem 110 is vertical database generation system. In addition to a user interface 111, this subsystem may include a classifier 112, a crawler module 113, an indexer 114 and a ranking system 115. The various modules are able to communicate over a common system bus 105, which may extend to or be replicated in the other subsystems, as will be further described below.

It will be understood by those skilled in the art that the various modules may consist of a combination of hardware and software components, including standard computer system components such as processors, memory, input/output units etc, which for the sake of simplicity are not shown in the drawing.

The search parameter interface is used during creation, maintenance and expansion of the vertical search system. Over this interface, a definition of one or more domains may be entered into the system. The domains represent the vertical domains, or topical domains, that will be available in the system 100. A list of these domains may be stored in a taxonomy table in the vertical database 140. According to some embodiments of the invention, categories stored in the taxonomy table represent the various sources from which a document may come, as already described above. However, the invention is not limited in this respect, and categories to be included in the taxonomy table could alternatively be defined for instance by a professional community (e.g. medical) and relate to various professions or categories within this community (e.g cardiology, radiology etc). In this respect the database may be seen as a collection of related vertical domains.

According to some embodiments of the invention, the database 140 is populated by documents that are manually added over the interface 111, selected for their quality and relevance, and categorized according to their origin as already referred to above.

In embodiments where documents are categorized according to their topical content, this may be achieved automatically or semi-automatically with the help of a classifier 112. A number of exemplary documents relevant to one or more categories may be input into the system 100 over the interface 111. The sample documents may typically be selected by one or more persons representing the professional community. According to some aspects of the invention, categories and documents may be added in order to expand or refine the search database over time.

Finally, over the interface 111 a number of seed URLs may be loaded into the subsystem 110. These URLs may refer to seed pages, or sites, on the Internet or in some other repository of documents.

The sample documents may then be passed to a classifier 112. The classifier may parse the sample documents and create a statistical representation of them, based e.g. on the number of times certain words occur. If the category is cardiology, dominating words may typically be such words as heart, blood, cardiology, etc.

The process of inputting sample documents into the classifier in order to generate these statistics may be referred to as training.

Based on the various statistics generated by the classifier for the various categories in the taxonomy table, the classifier will be able to classify additional documents. If, for example, an arbitrary document retrieved from the Internet is presented to the classifier 112, the classifier may parse the document, generate statistics and compare the statistics with the statistics created for the various categories during training. A measure of the similarity may then be generated, and this may be used as an indication of the degree to which the document can be considered as relevant to the particular category. The metrics used in this process may be referred to as category models or category models.

The classifier may be configured to classify each document as belonging to the one category with which it is most similar, or alternatively a document may be considered as belonging to several categories. Also, documents belonging to the same category may all be considered equally relevant, or their relevance may be weighted based on the degree of similarity with the training data. Documents may also be rejected as not being relevant to any of the categories.

Various techniques for text classification are known by those with skill in the art. For an example, reference is made to “Text Categorization with Support Vector Machines: Learning with Many Relevant Features”, by Thorsten Joachims, University at Dortmund, Informatik LS8, Baroper Str. 301, 44221 Dortmund, Germany, which is hereby incorporated by reference.

Further methods of ranking documents relative to each other will be discussed below.

In order to obtain documents for inclusion in the search database 140 the subsystem may further include a crawler 113. The crawler 113 may be delivered the URLs of a number of seed sites, or documents, as input. The selected sites may again be selected by one or more persons representing the professional community as representative quality documents. However, the documents may also be selected based on their assumed quality as starting points for the crawling process. This assumption does not have to be based only on the quality of the content of the document itself, but may also be based on how they reference other documents, e.g. by way of hyperlinks, and the location and assumed quality of the referenced documents.

The crawler 113 may parse the seed documents until it finds references to other documents. These referenced documents may then be retrieved and parsed in a similar manner for additional references to new documents. This process may be repeated, in principle indefinitely, and the number of collected documents will grow. A practical implementation of the crawler 113 may include the creation and maintenance of a crawler table where all URLs are stored. All documents referenced in the crawler table may then be revisited by the crawler 113 (i.e. retrieved again) at regular intervals. In this manner the crawler table is permanently updated and the indexed content, described further below, is refreshed.

If the retrieved documents are classified by their origin, the crawler 113 must follow strict rules regarding which links it can follow and from which sites or repositories it can retrieve documents. This classification can be based e.g. on the domain name of the site from where the document was retrieved, but in most cases more sophisticated rules than a simple reliance on top level domain will be necessary. Documents from a site with an EDU top level domain cannot normally not be relied upon as containing a publication officially originating from a school or university. Similarly, government documents can originate from different top level domains, not necessarily only from the GOV top level domain. In certain situations it may be considered necessary to categorize documents manually after they have been retrieved by the crawler 113.

According to embodiments where the documents are classified according to their content rather than their origin, the documents collected by the crawler 113 may be forwarded to the classifier 112, as described above, and the classifier 112 may determine whether any given document is sufficiently relevant to be included in the database 140.

As a matter of design choice, the crawler 113 may operate independently of the classifier 112. Alternatively, the crawler 113 may be configured to not follow links out of documents that are determined to be irrelevant by the classifier 112, not to follow links out of irrelevant documents that were linked to by irrelevant documents, or some similar rule. Such a rule may be imposed in order to avoid crawling irrelevant areas of the network.

Again, automatic classification by the classifier 112 may be replaced by or supplemented by manual classification.

In order to further process a document that has been classified as relevant to one or more categories, the subsystem 110 may include an indexer 114. The indexer creates an index of all retrieved documents in order to facilitate searching.

The documents that are classified as relevant may also be subjected to a ranking algorithm in a ranking module 115. As already mentioned, ranking may be based on the degree of relevance found by the classifier. Other ranking algorithms may be used instead of or in addition to the relevance measure, including algorithms based on link analysis, search term frequency etc.

According to some embodiments of the invention, several different ranking methods are possible

The vertical database generation subsystem 110 may be connected to the actual database 140 over a communications link 160. This communications link may also connect to the other subsystems as further described below. The communications link may be part of a local area or wide area network, or it may be part of or an extension of the system bus 105.

The various tables and results produced by the subsystem 110 may be stored in the database 140.

A second subsystem 120 may be present in some embodiments of the invention. The second subsystem is a dynamic ranking system. The dynamic ranking system 120 may include a ranking controller 121. The dynamic ranking system 120 may interact with a cache memory 150. According to some embodiments of the invention the cache memory 150 is present in order to allow refined searches to be performed on an existing result set by the search subsystem 130 (described below) or alternative ranking to be performed by the ranking subsystem 120.

A third subsystem may be the searching subsystem 130. This subsystem is accessible by users of the system 100 in order for such users to input search requests and receive search results and targeted messages. The search subsystem 130 may include a web server 131 capable of presenting search user interfaces and search results, and a search engine 132. The web server 131 is in communication with search clients 160 over one or more communication networks 170, e.g. the Internet.

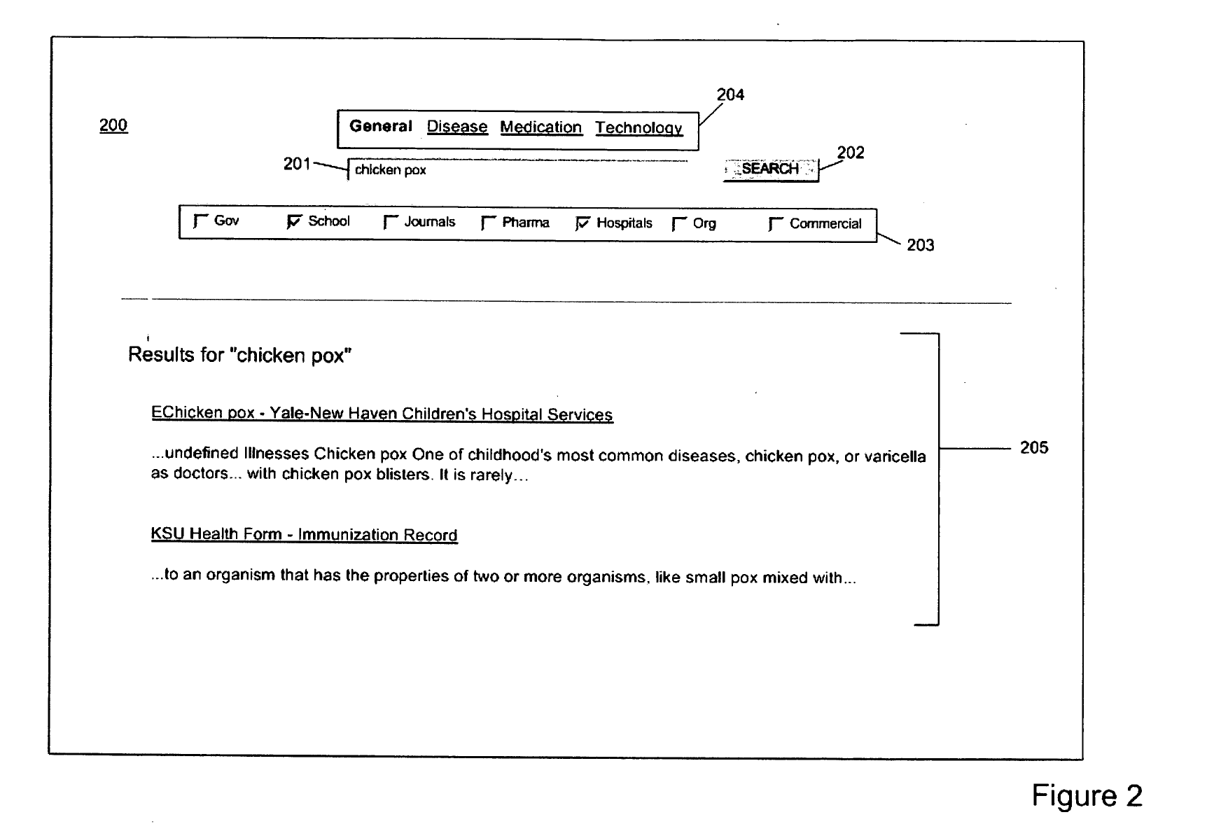

A user interface of the search client will be described in further detail below, with reference to FIG. 2.

From the web server 131, the search engine 132 receives search queries that may include several parts. A first part of a search query may be a text string representing search terms. A second part of a search query may be a representation of one or more categories used to narrow the search. Based on this input the search engine will perform a search in the vertical database 140 based on the document index stored there. According to certain aspects consistent with the principles of the invention, the search is only performed among documents classified in accordance with the one or more categorical identifiers included as a second part of the search query. As an example, only documents originating from journals are searched, and only documents containing the search terms included in the first part of the search query are retrieved as hits.

According to some embodiments of the invention the retrieved documents are ranked according to an already existing ranking (e.g. based on manual evaluation or link analysis that has already been used to assign a score to each document), a full or partial list of hits is generated, and this list is sent to the client 160 by the web server 131, e.g. in the form of an html formatted document.

In some embodiments the results, or hits, are temporarily stored in a cache memory. If a new search query is received representing a refinement of the first search query (i.e. one that by definition cannot include hits that are not already in the first result set), the second search may be performed only on the documents already in the result set stored in cache.

According to some embodiments, alternative ranking methods are available, as already described above. In such cases, a search query received by the web server 131 may include a third part identifying a desired ranking method or ranking alternative. The identified ranking alternative will then be selected when the hits are ordered and sent to the client 160. Various ranking alternatives (methods of scoring the documents) may have given a plurality of alternative scores in advance, in which case the ranking is simply a matter of choosing the relevant score for each document. Alternatively, ranking methods that include some information particular to the present search (e.g. based, at least partly, on the search terms) may be performed dynamically. This may be performed by the dynamic ranking module which may be configured to operate on the result set stored in cache in order to rank the documents included in the set based on the ranking method present as a third part of the search query.

It will be understood by those with skill in the art that the various subsystem may be tightly integrated into one, or distributed over several systems, according to design preferences. Similarly, the two databases may be residing in the same database system or be distributed over two or more database systems.

Reference is now made to FIG. 2 which illustrates a search interface 200 such as it may e.g. be presented in the window of a search client application installed on a client computer 160. The search client application may typically be a web browser. Examples of web browsers include OPERA, FIREFOX, KONQUEROR and INTERNET EXPLORER. Alternatively the user interface may be part of a dedicated search client application.

The user interface 200 provides the user with an input field 201 where search terms can be entered, and a SEARCH button 202 which when clicked will result in a transmission of a search query to the search engine (described in further detail below). Furthermore, the user interface includes a number of source categories 203 (exemplified here as Gov, School, Journals, Pharma, Hospitals, Org and Commercial). According to a first embodiment of the invention, documents indexed in the database are classified as originating from one of the available sources. According to an alternative embodiment, documents may be classified as originating from several sources (e.g. Pharma and Commercial in the case where the document is from a commercial pharmaceutical company, or School and Hospital in the case where the document is the result of a cooperation between a university and a hospital).

Above the input field in FIG. 2 there is illustrated four different ranking alternatives 204, in this case General, Disease, Medication and Technology. According to embodiments of the invention, clicking on one of these will change the ranking of the documents retrieved as the result of a search, but according to some embodiments of the invention the actual hits remain the same (i.e. the search result remains the same, but the ranking changes).

Finally, after a search has been performed, a list of hits 205 may be shown below the user input controls. Before any search has been performed there will, of course, not be any hits to display in this area of the user interface 200.

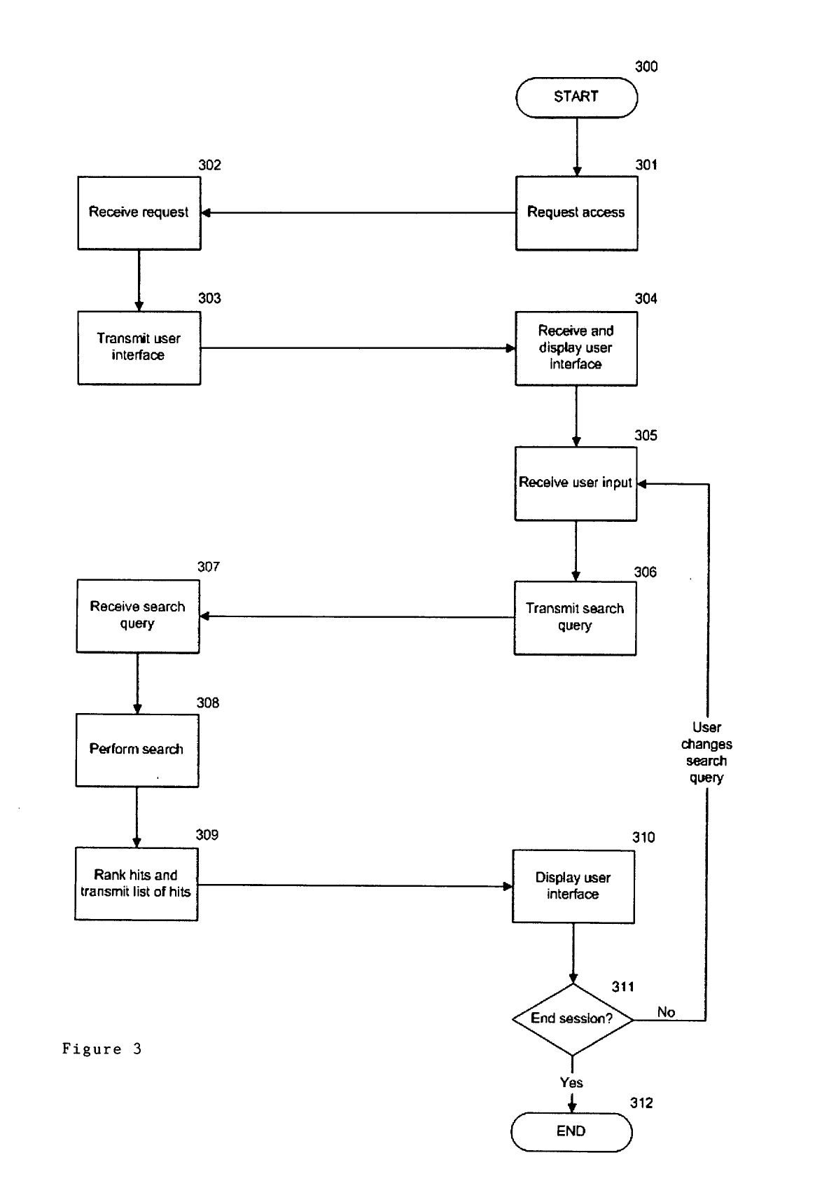

FIG. 3 illustrates in a flow chart how a search may be performed by a user and how the search results for one single search (i.e. for one particular string entered in the input field 301) can be changed by the user's manipulation of the alternatives available in the user interface 200 in a manner that is very efficient and represents very few steps for the user.

It will be understood by those with skill in the art that the transmission and receipt of information as illustrated in FIG. 3 may actually comprise additional transmissions of requests, responses, handshakes, acknowledgments etc. that have not been illustrated, and that the process also may include additional data elements or objects included in the exchanged of information between client and server, for example for purposes of data communication integrity or in order to provide the user with additional information.

The method starts in a first step 300.

In a second step 301 the user requests access to the search service. According to some embodiments of the invention this can be done by the user entering a URL (Uniform Resource Locater) in a web browser, and possibly also entering some kind of information confirming the user's right to access the service, e.g. a user name and a password. Alternatively the client application may be a dedicated application configured to contact the service automatically.

The request may then be transmitted to a server (or a collection of servers) from which the search service is available (typically using protocols that are well known in the art, such as for example TCP/IP and HTTP) and received by the server in a following step 302. Upon receiving the request 302, the server responds by providing access to the client. This may be done in a number of different ways depending on design choices and underlying communication infrastructure. According to the exemplary embodiment illustrated in FIG. 3, the server provides access by opening a session and transmitting 303 the user interface (e.g. as an html document) to the client.

When the client receives the user interfaces, it is displayed 304 in a window (200 in FIG. 2) of a client application (e.g. a web browser, as described above) on a display of a client computer (160 in FIG. 1).

Alternatively, the features of the user interface are already stored in the client computer and the server activates them by transmitting a confirmation that access to the service has been granted or that a session has been started.

The client application will now wait until it receives user input in a following step 305. The user input may be entered using the user interface illustrated in FIG. 2, and may according to some embodiments of the invention include a first part representing search terms, a second part representing categories to be searched (e.g. document sources), and a third part representing a ranking method.

When the search query has been entered by the user, the user may request execution of the search e.g. by clicking on a SEARCH button in the user interface. The client application reacts by transmitting the query 306 to the server, which receives it in a following step 307. Upon receiving the search query the server performs the search 308 by searching through indexed documents that are categorized as belonging to the one or more categories identified in the query, as already described. The result is a set of documents, referred to as hits. In a next step 309, the hits are ranked according to a ranking scheme. According to some embodiments of the invention only one ranking scheme is available. Alternatively, several ranking schemes may be available, and one may be chosen based on a third part of the search query, representing the desired ranking alternative. The ranked hits, or at least a subset of the hits, are then transmitted to the client. According to some embodiments, the set of hits are temporarily stored in the cache memory 150, as described above.

In a next step 310 the client receives the transmitted results and displays them along with, or as part of, the user interface. The client now waits for the user's next action 311. If the user chooses to end the search, e.g. by closing the client application or by selecting to retrieve one of the documents identified as part of the result set, the method ends in a final step 312. Alternatively the user can choose to change one or more parts of the search query, in which case the process returns to step 305.

The user can change the search query in several ways.

The first part of the search query can be expanded, such that additional hits are possible, for instance through the removal of a restrictive search term. In this case, when the server performs a new search in step 308, all the indexed documents in the relevant categories must be searched again.

The first part of the search query can be restricted, such that only additional restrictions have been added. In this case, unless the search categories have been changed, it may be sufficient to search through the existing result set in cache memory. (This alternative also covers the alternative where the user requests an additional part of the list of hits, e.g. hits 11 through 20 if the first transmission from the server only included hits 1 through 10.)

If the user has changed the categories that represent document sources (or some other defined domain to which documents belong), the search in step 308 must be performed on all indexed documents, or at least on all documents belonging to newly added categories. It is, however, within the scope of the invention to retain documents from the existing result set if they belong to categories that are included in the new search query, and if the first part of the search query has not been expanded.

If the user has not changed the first or second part of the search query, but has changed the third part of the search query, which represents the ranking alternative, the result set already existing in cache memory will simply be ranked again and sent to the client in a format representative of the new ranking, which most often will mean that the hits are represented in a different sequence (and/or a different subset of hits will be displayed).

Search clients 160 operating to submit search requests to a search server in accordance with the invention may be any electronic device with sufficient processing power, memory and a display, as well as communication capabilities enabling it to send requests to and receive results from a server. Typically, such a client may be a personal computer, but the invention is not limited in this respect, and devices such as PCAs, or smart phones are examples of alternative devices that may be used in conjunction with the invention.

A client device may have installed thereon a user agent application (e.g. a web browser) configured to receive instructions and data from the search server and rendering on the device display, any user interface elements and data received from the server for such display. The data may be received in the form of a mark up language document (e.g. HTML), and may also include script instructions (e.g. ECMAscript/Javascript).

A client device may also have installed thereon a client application capable of performing additional tasks of processing and configuring received instructions and data. Such an application may operate as a dedicated searching client capable of generating it's own user interface, or it may operate in conjunction with a user agent application (e.g. as a plug in).

1. A method in a client application running on an electronic client device, comprising:
displaying a user interface with a text input field and a plurality of selectable categories;
receiving user input including a text string representing search terms and a selection of one or more of said categories;
transmitting said text string as a first part of a search query and said selection of categories as a second part of a search query to a database containing an index of documents classified as belonging to at least one of said categories;
receiving, from said database, a search result listing documents that fulfill said first part of said search query and belong to categories listed in said second part of said search query;
presenting said listing of documents as part of said user interface along with said input field and said plurality of selectable categories; and
upon receiving new user input representing an update of at least said first part or said second part of said search query, transmitting an updated search query to said database.

2. The method of claim 1, further comprising:
displaying as part of said user interface, a plurality of selectable document ranking alternatives; and
when transmitting said search query, transmitting a selected ranking alternative as a third part of said search query.

3. The method of claim 1, wherein said text string is a regular expression.

4. The method of claim 2, wherein said new user input represents a change of at least said third part of said search query.

5. The method of claim 1, wherein said search request is transmitted as an http request.

6. The method of claim 1, wherein said search result is received as part of a mark up language document.

7. The method of claim 1, wherein said database contains documents relevant to a particular topic, and said categories represent types or categories of entities or sources providing documents relating to said topic.

8. A method for performing a search in an indexed database of documents on stored on a search server, comprising:
receiving, from a client device, a search query with a first part including a text string representing search terms and a second part representing one or more categories;
performing a search among documents that belong to at least one of said categories, for documents that correspond with said text string; and
transmitting, to said client device, a search result listing documents that fulfill said first part of said search query and belong to categories listed in said second part of said search query.

9. The method of claim 8, further comprising:
receiving as a third part of said search query, a selected ranking alternative; and
prior to transmitting said search result, arranging said documents in accordance with said selected ranking alternative.

10. The method of claim 8, further comprising:
transmitting, along with said search result, data representative of at least part of said search query, said data being formatted to be used as default values for in a user interface for receiving an updated search request from a user at said client device.

11. The method of claim 8, further comprising:
storing said search result in a cache memory on said server;
upon receiving an updated search request, determining whether said updated search request is capable of generating an updated search result including documents not included in the original search result; and
if it is determined that said updated search result cannot include documents not included in the original search result, performing an updated search based on said updated search query on said search result stored in cache memory.

12. The method of claim 8, wherein said database contains documents relevant to a particular topic, and said categories represent types or categories of entities or sources providing documents relating to said topic.

13. A computer system, comprising:
a database of indexed documents, each of said documents being categorized as belonging to at least one of a plurality of categories;
a web server configured to receive search queries from client devices and transmit search results to client devices; and
a search engine configured to perform searches of said database;
said computer system being configured to receive, from a client device, a search query with a first part including a text string representing search terms and a second part representing one or more categories;
perform a search among documents that belong to at least one of said categories, for documents that correspond with said text string; and
transmit, to said client device, a search result listing documents that fulfill said first part of said search query and belong to categories listed in said second part of said search query.

14. The computer system of claim 13, further comprising:
a ranking controller for ranking documents included in a search result according to a defined ranking method;
said computer system being further configured to receive as a third part of said search query, a selected ranking alternative; and
prior to transmitting said search result, arrange said documents in accordance with said selected ranking alternative.

15. The computer system of claim 13, further comprising:
a cache memory for temporarily storing said search result;
said computer system being further configured to, upon receiving an updated search request, determining whether said updated search request is capable of generating an updated search result including documents not included in the original search result; and
if it is determined that said updated search result cannot include documents not included in the original search result, performing an updated search based on said updated search query on said search result stored in cache memory.

16. The computer system of claim 14, further comprising:
a cache memory for temporarily storing said search result; and
configured to, upon receiving an updated search request including an updated ranking alternative, arrange said stored search result in accordance with said selected updated ranking alternative and retransmit said search result to said client device.

17. The computer system of claim 13, wherein said database contains documents relevant to a particular topic, and said categories represent types or categories of entities or sources providing documents relating to said topic.

18. A computer program product stored on a tangible computer-readable medium and including computer code for, when executed or interpreted by a processor, generating a visual user interface on a screen display of an electronic client device, comprising:
a set of instructions for generating, on said display, a representation of a user input field capable of receiving user input data in the form of a text string;
a set of instructions for generating, on said display, a representation of a set of document categories and capable of receiving user input data representing a selection of one or more of said categories;
a set of instructions for generating, on said display, a representation of a user invokable transmit function and capable of, when receiving user input representing an invocation of said function, passing data received in said input field and data received as representing a selection of one or more categories to said function to be transmitted as a first and a second part of a search query from said client device to a search server.

19. The computer program product of claim 18, further comprising:
a set of instructions for generating, on said display, a representation of a set of document ranking methods and capable of receiving user input data representing a selected one of said methods; and wherein said input data, upon user invocation of transmit function, is passed to said function as a third part of said search query.

20. The computer program product of claim 18, further comprising:
instructions for transferring data including said sets of instructions for generating representations to a program operating on said client device and configured to render said representations on said display.

21. The computer program product of claim 20, wherein said sets of instructions for generating include mark up language code.

22. The computer program product of claim 20, wherein said sets of instructions for generating include instructions in a script language.

23. The computer program product of claim 20, further comprising:
instructions for receiving, from a search server, data representing search results of a search query already performed by said search server as part of an ongoing search session, and for incorporating at least part of said data representing search results with said data including instructions prior to transferring data to said user agent.

24. The computer program product of claim 23, further comprising:
instructions for including data representative of a search query of said already performed search as default user input values with said data including instructions for for generating.

25. The computer program product of claim 18, configured to operate as part of said search server and to perform said transfer to said user agent by transmitting it over a computer communication network.

26. The computer program product of claim 18, configured to operate as part of an application running on said client device.

27. The computer program product of claim 18, wherein said search engine is configured to search a database containing documents relevant to a particular topic, and said categories represent types or categories of entities or sources providing documents relating to said topic.
